(19) United States
(12) Patent Application Publication
(10) Pub. No.: US 2009/0207547 A1
(43) Pub. Date: Aug. 20, 2009

(54) Ion Blower

(75) Inventor: Yasunori Terasaki, Tokyo (JP)

Correspondence Address: BIRCH STEWART KOLASCH & BIRCH, PO BOX 747, FALLS CHURCH, VA, 22040-0747, US

(73) Assignee: HUGLE ELECTRONICS INC., Tokyo (JP)

(21) Appl. No.: 11/665,123

(22) PCT Filed: Mar. 25, 2005
(86) PCT No.: PCT/JP2005/006443

§ 371 Date: Apr. 11, 2007

(51) Int. Cl. H01T 23/00

(52) U.S. Cl. 361/231

(57) ABSTRACT

In an ion blower 1 of the present invention, an opening/closing door 13 opens downward substantially by 90 degrees, so that discharge needles 16 are directed upward. In this case, since the direction of the discharge needles 16 do not intersect a blower body 10, at the time of maintenance, when the discharge needle 16 is pulled out, fingers and the hand move upward, and do not collide against the blower body 10 and the opening/closing door 13.

### TECHNICAL FIELD

The present invention relates to an ion blower that blows an airflow containing ions (plus ion, minus ion, or plus/minus ions) generated by corona discharge.

### BACKGROUND ART

The ion blower applies a high voltage to needle-like discharge electrodes (hereinafter, “discharge needles”) to generate ions from the air, and irradiates ions to an object to be electrically removed, which has been charged, to remove electricity. If a positive voltage is applied, plus ion is generated, and if a negative voltage is applied, minus ion is generated. In some ion blowers, a discharge needle to which the positive voltage is applied, and a discharge needle to which the negative voltage is applied are separately provided, to generate plus ion and minus ion simultaneously by these discharge needles (a so-called direct current ion blower).

One example of such an ion blower includes, for example, a plate-like glass substrate. This glass substrate is used for, for example, a thin-film transistor (TFT) liquid crystal panel, a plasma display panel (PDP), a liquid crystal display (LCD), and the like.

For example, Japanese Patent Application Laid-Open No. 2004-253193 is known as a conventional art of such an ion blower.

The outline of the conventional art is explained here with reference to accompanying drawings. FIG. 7 is a diagram of an ion blower in the conventional art, and FIG. 8 shows an arrangement of discharge needles. As shown in FIG. 7, an ion blower 100 includes a fan 101, a plurality of (in FIG. 8, four) discharge needles 102, a guard 103, a power source controller 104, and a support 105. The four discharge needles 102, as shown in FIGS. 7 and 8, are arranged on the inner circumference of the circular support 105, so that the discharge needles 102 are oriented to the center of the circle. When the ion blower 100 is operated, the power source controller 104 applies plus or minus high voltage to the discharge needles 102, and hence, plus ion or minus ion is discharged from the discharge needles 102. Furthermore, the power source controller 104 supplies power to the fan 101, and the fan 101 rotates to generate airflow. The plus ion or the minus ion is carried on the airflow and discharged from the ion blower 100. The ion blower 100 in the conventional art has such a configuration.

In the ion blower 100, since the high voltage is applied to the discharge needles 102 for a long period, the discharge needles 102 may deteriorate, or dust is attracted and adheres to the discharge needles 102, though the ion blower 100 is used in a clean room. Therefore, after a predetermined period has passed, replacement or cleaning of the discharge needles 102 is required.

In the ion blower 100 in the conventional art, however, as is obvious from FIG. 8, since the discharge needles 102 are extended toward the center of the circular support 105, there is a problem in that when the discharge needle 102 is pulled out or cleaned, the discharge needle 102 on the opposite side sticks into a finger or a hand by mistake. Furthermore, there is such a problem that even when the discharge needle 102 is pulled out by using nippers, not with the hand, it is difficult to apply force, or on the contrary, too much force is applied, to cause a collision with the discharge needle 102 or the support 105 on the other side.

Furthermore, to have a small structure as shown in FIG. 7, the space between the discharge needles 102 and the fan 101 becomes relatively narrow. Therefore, cleaning is difficult, and miniaturization is not easy.

As the diameter of the support 105 decreases, it is hard to put a hand in, thereby making maintenance difficult. Accordingly, in the ion blower 100 in the conventional art, the opening diameter of the support 105 cannot be made small too much, putting a restriction on the design.

When the discharge needles 102 including the support 105 are formed in a unit, to facilitate replacement, a mechanical structure for replacement becomes complicated, thereby causing an increase in the production cost.

The present invention has been achieved in order to solve the above problems, and it is an object of the present invention to provide an ion blower that realizes both simplification of maintenance such as cleaning and replacement of the discharge needles, and miniaturization.

### DISCLOSURE OF THE INVENTION

To solve the above problems, an ion blower according to claim 1 is an ion blower of corona discharge type including a blower body having a fan, an opening/closing door openably fitted to the blower body on an upstream side of an airflow by the fan, and discharge needles provided so as to be directed substantially in a perpendicular direction to the opening/closing door. When the opening/closing door is opened, the direction of all discharge needles does not intersect the blower body.

An ion blower according to claim 2 is the ion blower according to claim 1, wherein the opening/closing door opens downward, and is stable in the open state due to the dead weight of the opening/closing door.

An ion blower according to claim 3 is the ion blower according to claim 1 or 2, further including a support, and an adjusting unit that adjusts the blowing angle of the blower body with respect to the support and fixes the adjusted position.

An ion blower according to claim 4 is the ion blower according to claim 3, wherein the adjusting unit includes a body side adjusting plate in a disk shape having teeth on the disk, with teeth tips and teeth bottoms being on a radius of a circle, and fixed to the blower body, a support side adjusting plate in a disk shape having the same teeth as those on the body side adjusting plate and fixed to the support, and an angle fixing unit that brings the body side adjusting plate close to or separates away from the support side adjusting plate. The angle fixing unit is operated to separate the body side adjusting plate and the support side adjusting plate from each other, so that the blower body can be freely rotated with respect to the support. After the adjustment, the angle fixing unit is operated to bring the body side adjusting plate and the support side adjusting plate into contact with each other so that the teeth thereof engage with each other, thereby fixing the blower body with respect to the support.

An ion blower according to claim 5 is the ion blower according to any claims 1 to 4, wherein the discharge needle is formed integrally with a discharge needle stand, and at the time of replacement of the discharge needle, the discharge needle is replaced by detaching the discharge needle stand.

According to the present invention, an ion blower that realizes both simplification of maintenance such as cleaning and replacement of the discharge needles, and miniaturization can be provided.

### BRIEF DESCRIPTION OF THE DRAWINGS

FIG. 1 is a perspective appearance drawing of an ion blower in the best mode for carrying out the present invention;

FIG. 2 is a perspective appearance drawing of the ion blower in the best mode for carrying out the present invention, with an opening/closing door being open;

FIG. 3 is a schematic block diagram of the ion blower in the best mode for carrying out the present invention;

FIG. 4 is an explanatory diagram of a cleaning operation of the ion blower;

FIG. 5 is an explanatory diagram of an adjusting unit;

FIG. 6 is a structural drawing of a body side adjusting plate and a support side adjusting plate;

FIG. 7 is a diagram of an ion blower in the conventional art; and

FIG. 8 shows an arrangement of discharge needles.

### BEST MODE FOR CARRYING OUT THE INVENTION

Best mode for carrying out the invention will be explained below with reference to the drawings.

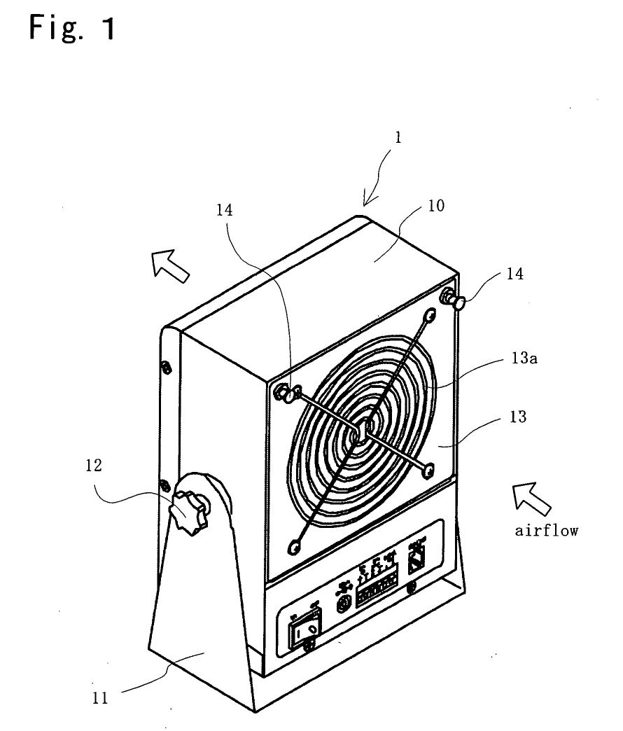

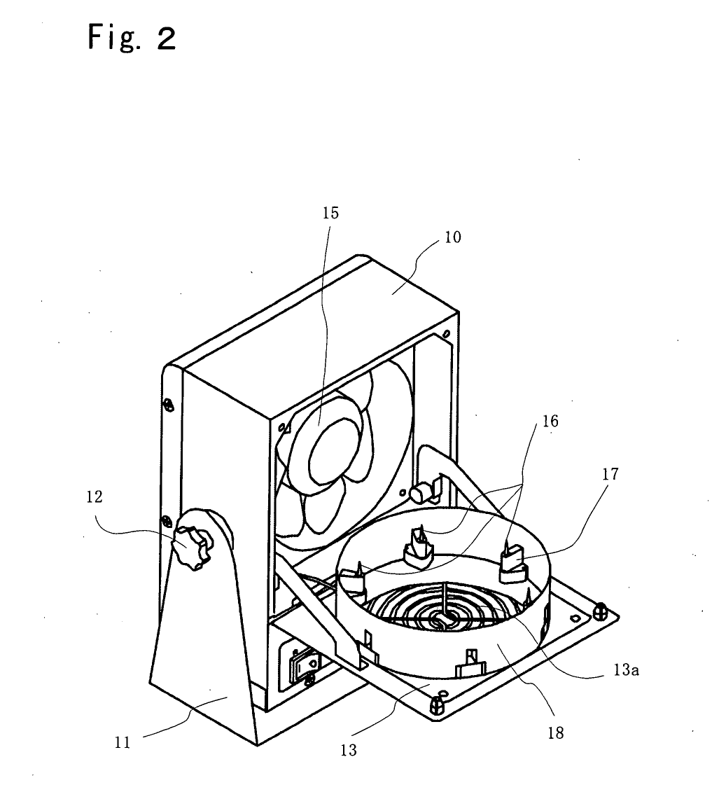

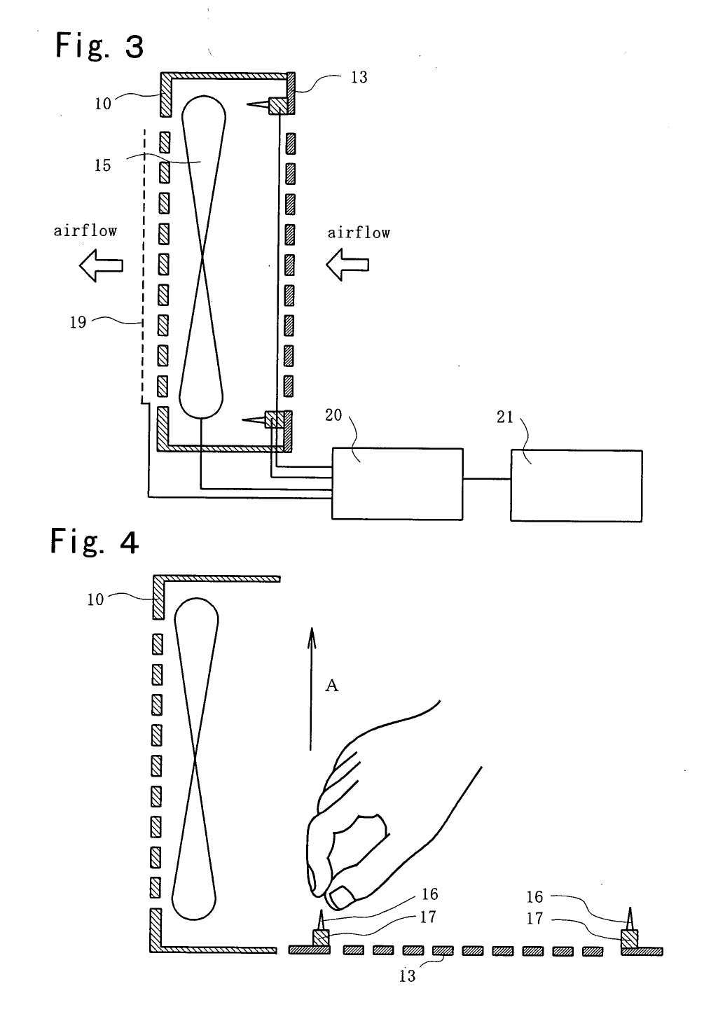

An ion blower 1 includes, as shown in FIG. 1, a blower body 10, a support 11, an adjusting unit 12, an opening/closing door 13, and a fixing unit 14. In the inside of the ion blower 1, as shown in FIGS. 2 and 4, a fan 15, discharge needles 16, discharge needle stands 17, and a flow path cylinder 18 are provided. A circuit system includes, as shown in FIG. 3, an ion balance sensor 19, a power source drive controller 20, and an operation unit 21. The power source drive controller 20 is connected to the fan 15, the discharge needles 16, the ion balance sensor 19, and the operation unit 21, and performs control as described later.

The respective units are explained first.

The blower body 10 has a substantially cubic shape, and as shown in FIG. 2, the opening/closing door 13 can be opened or closed. The fan 15 is provided therein.

The support 11 is a bent plate member having substantially a letter U shape, as seen from the flowing direction of airflow, as shown in FIGS. 1 and 2.

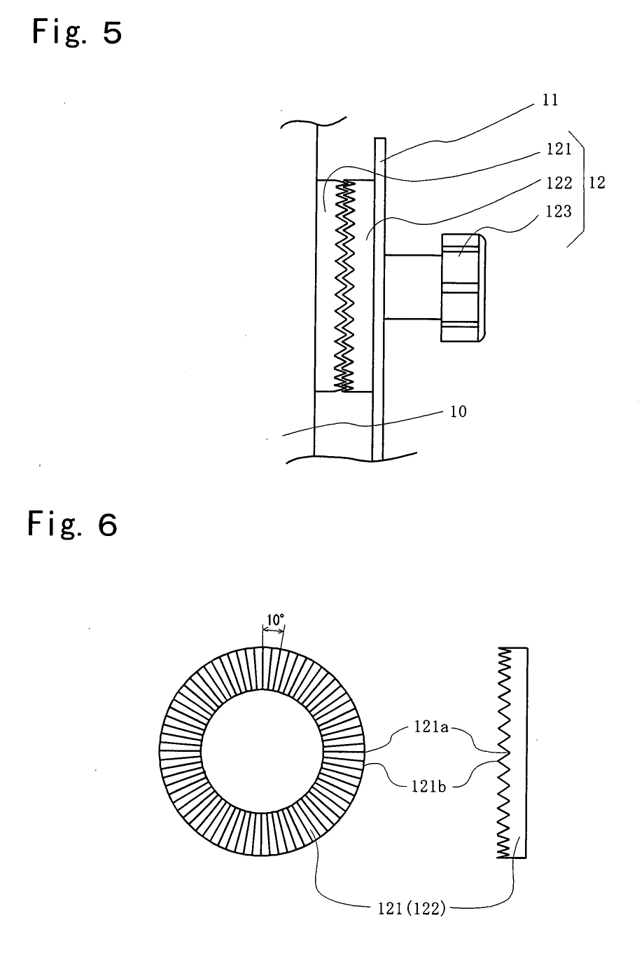

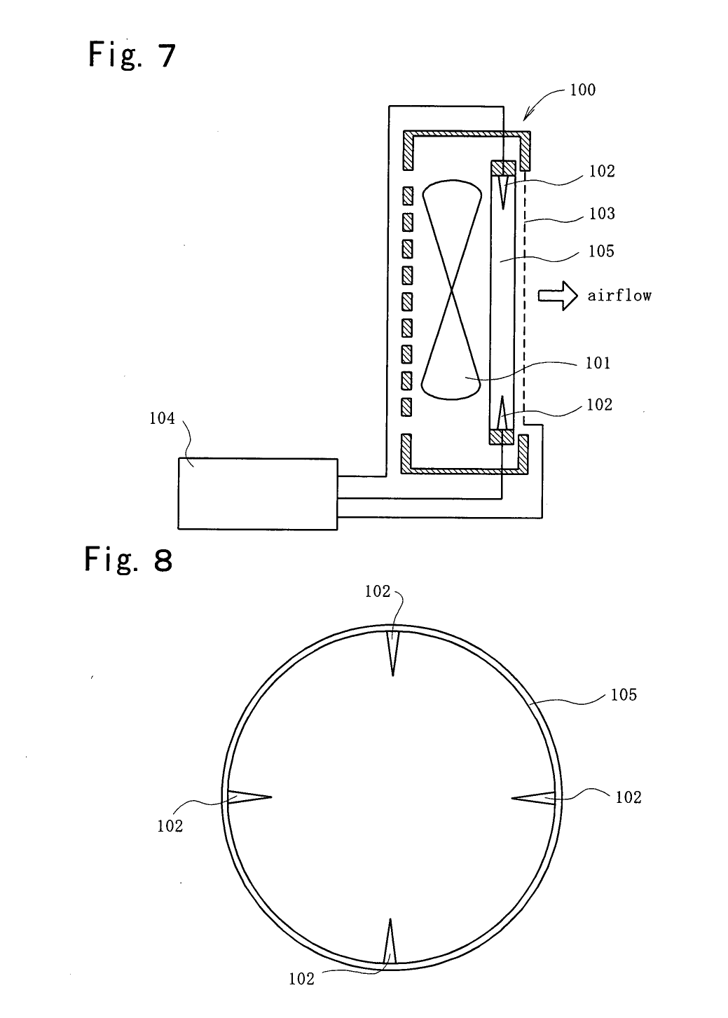

The adjusting unit 12 includes, as shown in FIGS. 5 and 6, a body side adjusting plate 121, a support side adjusting plate 122, and an angle fixing unit 123. The adjusting unit 12 is provided respectively on the both sides of the blower body 10, to fix the blower body 10 to the support 11. Adjustment by the adjusting unit 12 will be explained later.

The opening/closing door 13 is, as shown in FIG. 2, fixed to links rotating with respect to the blower body 10, so as to turn in the vertical direction. In this embodiment, as shown in FIG. 4, the opening/closing door 13 opens by turning substantially by 90 degrees, and stands still at a position substantially perpendicular to the blower body 10. As shown in FIGS. 1 and 2, an opening 13a is formed in the opening/closing door 13, from which the airflow flows in. The opening 13a is formed in a net-like shape by arranging multiple annular members in concentric circles, and has a function of protecting the fingers and the hand of an operator and foreign matter from coming in contact with the fan 15.

The fixing unit 14 is, as shown in FIG. 1, a member for fixing the opening/closing door 13 to the blower body 10, and for example, a so-called nylon latch formed so that insertion and pull-out thereof becomes easy.

The fan 15 is, as shown in FIG. 3, arranged in the blower body 10, and rotates due to a driving force supplied from the power source drive controller 20, to blow the airflow.

The discharge needle 16 is arranged, as shown in FIG. 2, on the discharge needle stand 17. As shown in FIG. 3, the discharge needles 16 generate ions due to the high voltage supplied from the power source drive controller 20. Here, explanation is given, assuming that the ion blower is a direct current type ion blower in which discharge needles 16 to which a positive voltage is applied and discharge needles 16 to which a negative voltage is applied are arranged one by one alternately. The number of discharge needles 16 is not limited to six in the embodiment, and any number can be appropriately selected according to need.

The flow path cylinder 18 restricts the flow path of the airflow from the opening 13a of the opening/closing door 13, so that ions reach the fan 15 reliably.

The ion balance sensor 19 is made of metal, has electroconductivity, and is constructed by integrally forming a plurality of linear of tabular circular tubes in a concentric circular shape (as in the opening 13a in FIG. 1). The ion balance sensor 19 detects the current yield of plus ion and minus ion, to obtain a desired ion balance. The ion balance sensor 19 transmits a detection signal to the power source drive controller 20. The ion balance sensor 19 is formed in a net-like shape, so as to prevent a user from inserting a finger by mistake.

The power source drive controller 20 includes a power source, a driving unit, and a control unit, to control ion generation as described below.

The operation unit 21 is for an operator to perform various kinds of desired setting with respect to the power source drive controller 20.

A flow path is formed in the ion blower 1, through which the air flows, and the airflow sequentially passes, in order of from the upstream side, the opening 13a of the opening/closing door 13, the fan 15, the opening of the blower body 10, and the ion balance sensor 19. In this flow path from the opening 13a of the opening/closing door 13 to the fan 15, the flow path is blocked by the flow path cylinder 18, and the discharge needles 16 are arranged within the flow path cylinder 18. As a result, the generated plus ion and minus ion reliably reach the fan 15.

An operation of the ion blower 1 is briefly explained here.

When an operator turns on a power switch in the operation unit 21, the fan 15 starts to rotate, and plus ion and minus ion are generated by the discharge needles 16. As is seen from FIG. 3, the discharge needles 16 are directed toward the fan 15, and hence, plus ion and minus ion are discharged toward the fan 15. When an air volume-adjusting volume of the operation unit 21 is adjusted, the rotation speed of the fan 15 changes to control the amount of airflow.

In this ion balance control, the power source drive controller 20 adjusts the positive and negative voltages to be applied to the discharge needles 16 so as to control the ion balance based on the detection signal from the ion balance sensor 19. When it is determined from the detection signal that minus ions are generated more than the plus ions, the power source drive controller 20 raises the voltage to be applied to the discharge needles 16 for plus ions to a higher voltage (for example, raises the voltage from +20V to +24V), to increase the plus ion. Alternatively, the power source drive controller 20 raises the voltage to be applied to the discharge needles 16 for minus ions to a higher voltage on the positive side (for example, raises the voltage from −24V to −20V), to decrease the minus ion.

Likewise, When it is determined from the detection signal that plus ions are generated more than the minus ions, the power source drive controller 20 lowers the voltage to be applied to the discharge needles 16 for plus ions to a lower voltage (for example, lowers the voltage from +24V to +20V), to decrease the plus ion. Alternatively, the power source drive controller 20 lowers the voltage to be applied to the discharge needles 16 for minus ions to a lower voltage on the negative side (for example, lowers the voltage from −20V to −24V), to increase the minus ion.

When an ion balance-adjusting volume of the operation unit 21 is adjusted, the ion balance is balanced, which has been unbalanced heretofore, or plus and minus balance may be intentionally biased and output.

In this ion blower 1, particularly by using the adjusting unit 12 as shown in FIGS. 5 and 6, the blowing angle can be adjusted. The body side adjusting plate 121 is fixed to the blower body 10, and the support side adjusting plate 122 is fixed to the support 11. The body side adjusting plate 121 and the support side adjusting plate 122 are both in a disk shape, and ring-shaped teeth are formed on the disk so that teeth bottoms 121a and teeth tips 121b are on the radius of the circle, and one teeth bottom 121a is shifted from the adjacent teeth bottom 121a by 10 degrees. When the angle fixing unit 123 is rotated, the support side adjusting plate 122 can be brought close to or separated away from the body side adjusting plate 121. The angle fixing unit 123 is operated to separate the body side adjusting plate 121 and the support side adjusting plate 122 from each other, so as to make the blower body 10 rotatable with respect to the support 11. After the adjustment, the angle fixing unit 123 is operated to make the teeth of the body side adjusting plate 121 and the support side adjusting plate 122 engage with each other, and fix the blower body 10 to the support 11. By the teeth, angle adjustment becomes possible by 10 degrees. Since the teeth engage with each other, once the body side adjusting plate 121 is fixed to the support side adjusting plate 122, rotation thereof is prevented reliably.

The maintenance of the ion blower 1 is explained next. At first, the fixing units 14 shown in FIG. 1 are removed, to open the opening/closing door 13 as shown in FIGS. 2 and 4. The opening/closing door 13 opens substantially perpendicularly to the blower body 10, and the discharge needles 16 fitted so as to be directed substantially in a vertical direction with respect to the plate-like opening/closing door 13 can be seen. In this case, when the opening/closing door 13 is opened, the direction of all discharge needles 16 is upward, which does not intersect the blower body 10 (noncrossover). As shown in FIG. 4, a direction that the discharge needles 16 extend and a direction of pulling out the discharge needles 16 agree with each other (in a direction indicated by arrow A). However, since the blower body 10 is not in the pulling direction, at the time of pulling the discharge needle 16, a collision with the blower body 10 does not occur, thereby facilitating pulling out of the discharge needles, without paying attention. Since the opening/closing door 13 is stabilized in the open state due to the dead weight, replacement and cleaning of the discharge needles 16 are facilitated.

Furthermore, in the ion blower 1 of the present invention, since the maintenance becomes easy, the time required for maintenance can be reduced. Particularly, the time for suspending the actual production line accompanying the maintenance is reduced, thereby contributing to an improvement in the yield and reduction of the production cost. Furthermore, since maintenance is possible from the back side, not from the production line side as in the conventional art, maintenance becomes easy. Since some dust generated at the time of maintenance scatters outside of the production line, dust and dirt are prevented from adhering on the production line.

The ion blower in the embodiment has been explained. The ion blower in the embodiment can be variously modified. For example, in the embodiment, a configuration in which the discharge needle 16 is directly inserted into or pulled out from the discharge needle stand 17 is adopted. However, the discharge needle stand 17 and the discharge needle 16 may be formed integrally, and the discharge needle stand 17 and the opening/closing door 13 can be coupled together, thereby facilitating insertion and pulling out.

For the opening/closing door 13, such a configuration that the opening/closing door 13 opens substantially by 90 degrees so as to be perpendicular to the blower body 10, as shown in FIGS. 2 and 4, is adopted. However, the direction of all discharge needles 16 needs only to be noncrossover with respect to the blower body 10, and for example, when the opening/closing door 13 has a structure of opening by 90 to 180 degrees, replacement of the discharge needles 16 becomes sufficiently easy. Thus, a widely openable opening/closing door may be adopted.

A vertically opening configuration in which the opening/closing door 13 is opened vertically is adopted, but a laterally opening configuration may be adopted. Also in this case, the discharge needles on the opening/closing door need only to open so as to be noncrossover with respect to the blower body. For example, if the opening/closing door has a configuration to open by 90 to 180 degrees, replacement of the discharge needles becomes sufficiently easy.

The present invention is also applicable to an alternating current type ion blower that generates the plus ion and the minus ion alternately by applying AC high voltage to the individual discharge needle.

1. An ion blower of corona discharge type comprising:
a blower body having a fan;
an opening/closing door openably fitted to the blower body on an upstream side of an airflow by the fan; and
discharge needles provided so as to be directed substantially in a perpendicular direction to the opening/closing door, wherein
when the opening/closing door is opened, the direction of all discharge needles does not intersect the blower body.

2. The ion blower according to claim 1, wherein the opening/closing door opens downward, and is stable in the open state due to the dead weight of the opening/closing door.

3. The ion blower according to claims 1 or 2, further comprising:
a support; and
an adjusting unit that adjusts the blowing angle of the blower body with respect to the support and fixes the adjusted position.

4. The ion blower according to claim 3, wherein the adjusting unit comprises:
a body side adjusting plate in a disk shape having teeth on the disk, with teeth tips and teeth bottoms being on a radius of a circle, and fixed to the blower body;
a support side adjusting plate in a disk shape having the same teeth as those on the body side adjusting plate and fixed to the support; and
an angle fixing unit that brings the body side adjusting plate close to or separates away from the support side adjusting plate, wherein
the angle fixing unit is operated to separate the body side adjusting plate and the support side adjusting plate from each other, so that the blower body can be freely rotated with respect to the support, and after the adjustment, the angle fixing unit is operated to bring the body side adjusting plate and the support side adjusting plate into contact with each other so that the teeth thereof engage with each other, thereby fixing the blower body with respect to the support.

5. The ion blower according to claim 1, wherein the discharge needle is formed integrally with a discharge needle stand, and at the time of replacement of the discharge needle, the discharge needle is replaced by detaching the discharge needle stand.
